(19) United States
(12) Patent Application Publication
(10) Pub. No.: US 2026/0080096 A1
(43) Pub. Date: Mar. 19, 2026

(54) INPAINTING ANONYMIZED CONTENT IN A SHARED PHOTOGRAPHIC IMAGE

(71) Applicant: MOTOROLA MOBILITY LLC, WILMINGTON, DE (US)

(72) Inventors: AMIT KUMAR AGRAWAL, BANGALORE (IN); PANDURANGA REDDY PAILLA, NALGONDA (IN); VIJAYPRAKASH IDLUR, BANGALORE (IN)

(21) Appl. No.: 18/888,097

(22) Filed: Sep. 17, 2024

(51) Int. Cl. G06F 21/62; G06T 11/60; G06V 10/26; G06V 20/62; G06V 20/70; G06V 30/19

(52) U.S. Cl. CPC G06F 21/6254; G06T 11/60; G06V 10/26; G06V 20/62; G06V 20/70; G06V 30/191; G06T 2200/24; G06V 2201/10

(57) ABSTRACT

An electronic device, a method, and a computer program product automatically anonymize personally identifiable information (PII) in photographic images by inpainting anonymized intelligible descriptive data to appear more natural than blurring or blocking PII. The electronic device detects selection of photographic image(s) for communicating to second device(s) that provide access for presentation to second person(s). In response to determining that the photographic image(s) contains PII, the electronic device delineates the photographic image(s) into multiple segments including first segment(s) encompassing and separating the PII from remaining segments of content that is not PII. The electronic device inpaints anonymized intelligible descriptive data in the first segment(s) containing the PII to prevent sharing of the PII when the photographic image(s) is presented or displayed to the second person(s).

### BACKGROUND

### 1. Technical Field

The present disclosure relates generally to electronic devices that can modify photographic images, and more particularly to electronic devices that can modify and share photographic images.

### 2. Description of the Related Art

Electronic device users often share photographic images of themselves to others, such as on social media platforms. Occasionally, these photographic images include personal identifying/identifiable information (PII) that is not intended to be shared. Whether deliberate or inadvertent, sharing personally identifiable information (PII) in public forums presents a risk for the person associated with the PII. Unscrupulous individuals can use the PII to commit identity theft and other malfeasance. Although many people are careful with what they transmit to others or post on social media, mistakes happen.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a communication device in which the features of the present disclosure are advantageously implemented for automatically anonymizing personally identifiable information (PII) in photographic images by inpainting anonymized intelligible descriptive data, according to one or more embodiments;

FIG. 2 is a front view of a display of the communication device of FIG. 1 presenting a personal information anonymization (PIA) interface window for selecting and anonymizing PII contained in photographic images accessed from a gallery, according to one or more embodiments;

FIG. 3 illustrates a photographic image containing multiple examples of PII, according to one or more embodiments;

FIG. 4 presents a close-up view of one of the examples of PII in FIG. 3, according to one or more embodiments;

FIG. 5 illustrates the photographic image of FIG. 3 with sections inpainted with anonymized intelligible descriptive data, according to one or more embodiments;

FIG. 6 presents a close-up view of one of the examples of anonymized intelligible descriptive data in FIG. 5, according to one or more embodiments;

FIG. 7 is a flow diagram presenting a method for automatically anonymizing personally identifiable information (PII) in photographic images by inpainting anonymized intelligible descriptive data, according to one or more embodiments; and

FIGS. 8A-8B (collectively “FIG. 8”) are a flow diagram presenting a method that may augment the method of FIG. 7 with additional features for identifying PII and inpainting with anonymized intelligible descriptive data, according to one or more embodiments.

### DETAILED DESCRIPTION

According to aspects of the present disclosure, an electronic device, a method and a computer program product automatically anonymize personally identifiable information (PII) in photographic images by inpainting anonymized intelligible descriptive data, which is non-PII data. The non-PII data gives a general appearance of the PII as compared to blurring or covering with a solid shape. In one or more embodiments, the electronic device includes at least one input device. The electronic device includes a memory having a personal information anonymization (PIA) module. The electronic device includes a communications subsystem by which the electronic device communicatively connects to one or more second device, via a network. A controller of the electronic device is communicatively coupled to the at least one input device, the memory, and the communications subsystem. In response to detecting selection of at least one photographic image for communicating to at least one second device that is configured to provide access for presentation of the at least one photographic image to at least one second person, the controller is configured to cause the electronic device to identify whether the at least one photographic image contains personally identifiable information (PII). In response to determining that the at least one photographic image contains PII, the controller is configured to cause the electronic device to delineate the at least one photographic image into multiple segments. The multiple segments include at least one first segment encompassing and separating the PII from remaining segments of non-PII content of the at least one photographic image. The controller is configured to cause the electronic device to inpaint anonymized intelligible descriptive data in the at least one first segment containing the PII to prevent sharing of the PII when the at least one photographic image is presented or displayed to the at least one second person.

Inadvertent sharing of PII in photographs can occur without the user being aware that the photograph includes the PII. For example, a high-resolution image that is shared or posted can be zoomed-in on to reveal PII as small as a credit card or driver's license number if the credit card/driver's license is located at a visible angle on a surface next to a person who is the primary focus of the shared photograph. Accordingly, sharing PII within digital photographs may easily occur without the device user even noticing that PII text is legible within the photograph. In another example, the electronic device, which is being operated by a user, may have an integral or connected display being viewed by a second person and which presents a photographic image containing PII that can be seen by the second person.

Tools exist to remove an image of a person or other object from a digital photographic image. Improvements of the technology have included inpainting background imagery that realistically erases the person or the other object. The present disclosure does not attempt to extend a background across an omitted object, but rather leverages technology such as generative artificial intelligence (AI) to replace the PII with intelligible content that can correspond to an object or other non-PII content that remains in the photographic image. Unlike traditional AI systems that rely on explicit programming and rules, generative AI has the ability to generate content, such as text, images, or even music, autonomously. At its core, generative AI utilizes deep learning models, often built upon architectures, such as Generative Pre-trained Transformer (GPT), to understand patterns, relationships, and features within vast datasets. These models, trained on diverse and extensive data, gain the capability to generate new, coherent content that often mimics human-like creativity. One aspect of generative AI is its versatility, being applicable across various domains from natural language processing to image synthesis and beyond. In the realm of natural language, for instance, generative AI can compose text, answer questions, and even engage in coherent conversations, showcasing its potential in human-like language generation. According to aspects of the present disclosure, generative AI is used to remove smaller resolution images to remain PII such as vehicle registration numbers, personal identification numbers, etc., that are replaced with similar intelligible small images, retaining the general adornments of objects in the photographic image.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

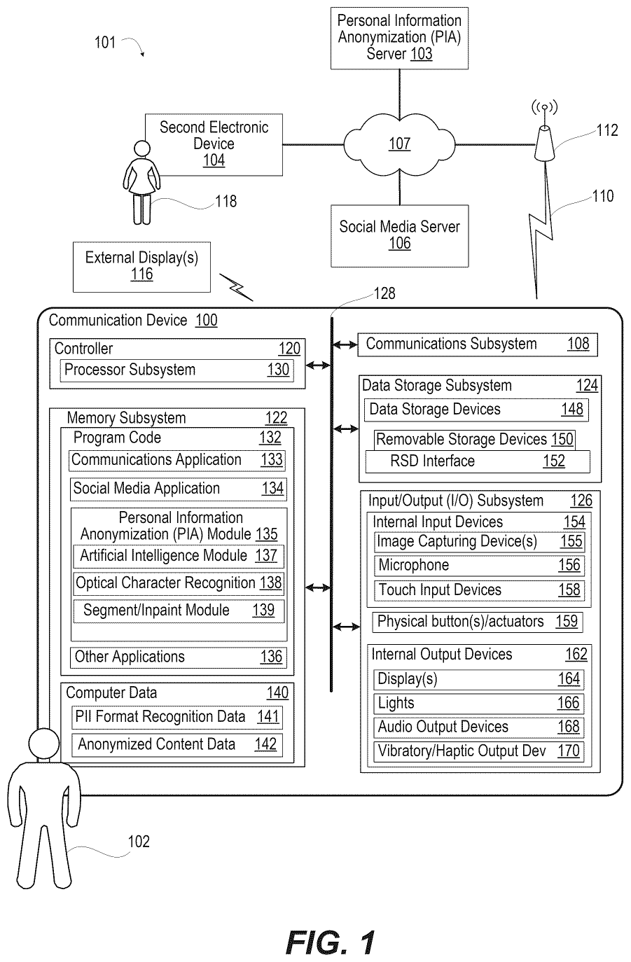

FIG. 1 presents a simplified functional block diagram of an electronic device in which the features of the present disclosure are advantageously implemented to automatically anonymize personally identifiable information (PII) in photographic images by inpainting anonymized intelligible descriptive data. In one or more embodiments, the electronic device includes additional communications functionality that enables electronic device to be referred to as communication device 100, which operates as a mobile user device for user 102 in communication environment 101. Aspects of the present disclosure may be implemented at least in part in PIA server(s) 103 that includes some or all of the components and functionality described herein. In the specific example of FIG. 1, communication environment 101 includes one or more second electronic device 104 and social media server(s) 106, which are accessible to communication device 100 through communication network 107. Communications device 100 includes communications subsystem 108 that connects via wired or wireless channel 110 to node 112 (e.g., wireless access point, cellular tower) to communicatively connect to PIA server(s) 103, second electronic device(s) 104, and social media server(s) 106 via one or more communication network 107. Communications device 100, via communications subsystem 108 and wired or wireless channel 110, may connect to external display(s) 116. One or more second person 118 may access and view photographic images communicated to second electronic device(s) 104, social media server(s) 106, and external display(s) 116.

Communication device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices. User 102 may use one or more second electronic devices similar or identical to communication device 100 with preferences shared across devices.

In addition to communications subsystem 108 and controller 120, communication device 100 may include memory subsystem 122, data storage subsystem 124 and input/output (I/O) subsystem 126. To enable management by controller 120, system interlink 128 communicatively connects controller 120 with communications subsystem 108, memory subsystem 122, data storage subsystem 124 and I/O subsystem 126. System interlink 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIG. 1, it is to be understood that more, fewer, or different interconnections may be present in other embodiments.

Controller 120 includes processor subsystem 130, which includes one or more central processing units (CPUs) or data processors. Processor subsystem 130 can include one or more digital signal processors and graphics processing units (GPUs), etc. that can be integrated with data processor(s). Processor subsystem 130 can include other processors such as auxiliary processor(s) that may act as a low power consumption, always-on sensor hub for physical sensors. Controller 120 manages, and in some instances directly controls, the various functions and/or operations of communication device 100. These functions and/or operations include, but are not limited to including, application data processing, communication, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

Memory subsystem 122 (or memory 122) stores program code 132 for execution by processor subsystem 130 to provide the functionality described herein. Program code 132 includes applications such as communication application 133 for communicating with second electronic device(s) 104, social media application 134 for interacting with social media server(s) 106, and PIA module 135, and other applications 136. PIA module 135 may include artificial intelligence (AI) model 137, optical character recognition module 138, and segment/inpaint module 139.

In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner. Memory subsystem 122 further includes operating system (OS), firmware interface, such as basic input/output system (BIOS) or Uniform Extensible Firmware Interface (UEFI), and firmware, which also includes and may thus be considered as program code 132.

Program code 132 may access, use, generate, modify, store, or communicate computer data 140, such as PII format recognition data 141 and anonymized content data 142 for PIA module 135 to use in replacing PII. Computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 100 or be retrieved from a remote device via communications subsystem 108. Communication device 100 may store, modify, present, or transmit computer data 140, such as anonymized content data 142. Computer data 140 may be organized in one of a number of different data structures. Common examples of computer data 140 include video, graphics, text, and images. Computer data 140 can also be in other forms of flat files, databases, and other data structures.

Data storage subsystem 124 of communication device 100 includes data storage device(s) 148. Controller 120 is communicatively connected, via system interlink 128, to data storage device(s) 148. Data storage subsystem 124 provides program code 132 and computer data 140 stored on nonvolatile storage that is accessible by controller 120. For example, data storage subsystem 124 can provide a selection of program code 132 and computer data 140. These applications can be loaded into memory subsystem 122 for execution/processing by controller 120. In one or more embodiments, data storage device(s) 148 can include hard disk drives (HDDs), optical disk drives, and/or solid-state drives (SSDs), etc. Data storage subsystem 124 of communication device 100 can include removable storage device(s) (RSD(s)) 150, which is received in RSD interface 152. Controller 120 is communicatively connected to RSD 150, via system interlink 128 and RSD interface 152. In one or more embodiments, RSD 150 is a non-transitory computer program product or computer readable storage device that stores program code and/or instructions that may be executed by a processor associated with a user device such as communication device 100. Controller 120 can access data storage device(s) 148 or RSD 150 to provision communication device 100 with program code 132 and computer data 140.

I/O subsystem 126 may include internal input devices 154 such as image capturing device(s) 155, microphone 156, and touch input devices 158 (e.g., screens, keys, or buttons). I/O subsystem 126 may include physical buttons/actuators 159 that can be located on a periphery of the device housing. I/O subsystem 126 may include internal output devices 162 such as display(s) 164, lights 166, audio output devices 168, and vibratory or haptic output devices 170.

In one or more embodiments, controller 120, via communications subsystem 108, performs multiple types of cellular over-the-air (OTA) connections. In one or more embodiments, controller 120, via communications subsystem 108, may communicate via an OTA cellular connection with radio access networks (RANs). In an example, communication device 100, via communications subsystem 108, connects via RANs of a terrestrial network that is communicatively connected to a network server. In one or more embodiments, controller 120, via communications subsystem 108, communicates via a wireless local area network (WLAN) link using one or more IEEE 802.11 WLAN protocols with an access point. In one or more embodiments, controller 120, via communications subsystem 108, performs other types of wireless communication, such as by using a Bluetooth connection or other personal access network (PAN) connection. In an example, a user may wear a health monitoring device such as a smartwatch that is communicatively coupled to communication device 100 via a wireless connection. In one or more embodiments, communications subsystem 108 includes a global positioning system (GPS) module that receives GPS broadcasts from GPS satellites to obtain geospatial location information, which enables communication device 100 to self-locate, among other features.

In one or more embodiments, PIA module 135 includes AI model 137 that is trained to recognize PII within segment(s) of a photographic image and inpaint the PII with anonymized intelligible descriptive data that is not PII. PIA module 135 and AI model 137 may be stored in memory subsystem 122 of communication device 100 and be executed by controller 120 to perform various aspects of the functionality of the present disclosure. Training of AI model 137 is the process by which AI models are trained to perform specific tasks or achieve certain objectives. The training involves providing the model with a large amount of data and allowing the model to learn from patterns and relationships within that data. Controller 120 may include various functionalities that enable controller 120 to perform different aspects of AI models. AI models may include an artificial neural network, a decision tree, a support vector machine, Hidden Markov model, linear regression, logistic regression, Bayesian networks, and so forth. The AI models can be individually trained to perform specific tasks and can be arranged in different sets of AI models to generate different types of output.

According to aspects of the present disclosure, in response to detecting selection of at least one photographic image for communicating to at least one second device 104 that is configured to provide access for presentation of the at least one photographic image to at least one second person 118, controller 120 is configured to cause communication device 100 to identify whether the at least one photographic image contains personally identifiable information (PII). Specifically, in one or more embodiments, controller performs a frame by frame detailed analysis of content presented in each section of the image. In response to determining that the at least one photographic image contains PII, controller 120 is configured to cause communication device 100 to section/segment/delineate the at least one photographic image into multiple segments comprising at least one first segment encompassing and separating the PII from remaining segments of non-PII content of the at least one photographic image. Controller 120 is configured to cause communication device 100 to inpaint anonymized intelligible descriptive data in the at least one first segment containing the PII to prevent sharing of the PII when the at least one photographic image is presented or displayed to the at least one second person.

In one or more embodiments, in identifying whether the at least one photographic image contains the PII, controller 120 is configured to cause communication device 100 to identify whether the at least one photographic image once communicated to the one or more second electronic device will contain an indication of user 102 of communication device 100 being associated with the at least one or more photographic images. The at least one indication may be presumed based on the at least one photographic image being taken from a storage location of the image being an output file folder assigned to at least one image capturing device of the electronic device. The at least one photographic image would likely have originated by with the user triggering capture of the at least one photographic image. Contents of the at least one of photographic image may thus contain indications of a location where the user was. The at least one photographic image may contain personal objects associated with the user. The at least one indication may be determined based on metadata associated with the image that identify the user. The metadata may remain with the image after communication, providing the indication. Alternatively, the metadata may be “tagging” manually added by another person or automatically added by facial recognition by another system that would alert a recipient as to the identity of the user. The at least one indication may be determined based on facial identification of the user contained in the one or more photographic image. With the user being found within the at least one photographic image, other objects within the at least one photographic image would be associated with the user, requiring screening for PII.

In one or more embodiments, in identifying whether the at least one photographic image contains the PII, controller 120 is configured to cause communication device 100 to perform optical character recognition of text-based content contained in the at least one photographic image. Controller 120 is configured to cause communication device 100 to compare the text-based content with one or more example text that correspond in at least one of form or content to one or more predesignated PII text-based content that should not be shared. Controller 120 is configured to cause communication device 100 to redact text-based content identified as containing the PII text-based content. Controller 120 is configured to cause communication device 100 to replace the text-based content with intelligible descriptive text identified as a generic substitute text. In one or more embodiments, each PII is classified at pertaining to a particular type of PII (e.g., home address, identification number, location of the user, etc.). Controller 120 looks up non-PII text that is of the same type of information. In one or more particular embodiments, controller 120 is configured to cause communication device 100 to identify a text format for PII types from among: (i) location address; (ii) location coordinates; (iii) transportation ticketing number; (iii) government assigned identification; (iv) financial account number; (v) vehicle tag identification; and (iv) contact communication information.

In one or more embodiments, in analyzing the at least one photographic image for one or more candidate segments that contain PII text-based content; controller 120 is configured to cause communication device 100 to train an artificial intelligence engine with user information associated with a user of the electronic device and with one or more conventional PII formats to identify the PII text-based content associated with the user. In one or more particular embodiments, the PII is or includes alphanumeric content associated with user 102 of communication device 100, and controller 120 is configured to cause communication device 100 to identify one or more descriptive characteristics of content within the photographic image. Controller 120 is configured to cause communication device 100 to generate intelligible descriptive alphanumeric content that is associated with the one or more descriptive characteristics of the content within the photographic image. Then, to inpaint the anonymized intelligible descriptive data, controller 120 is configured to cause communication device 100 inpaint the intelligible descriptive alphanumeric content.

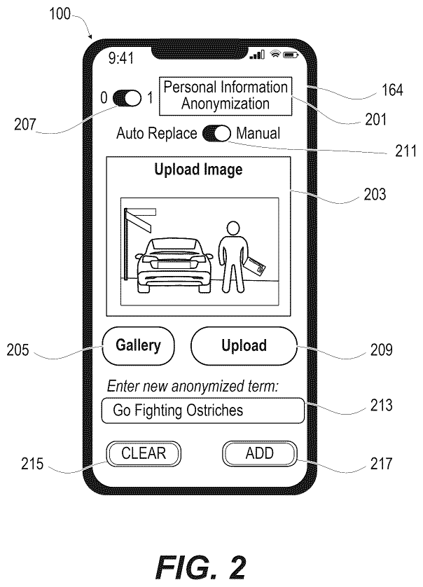

FIG. 2 is a front view of display 164 presenting PIA interface window 201 for selecting photographic images 203 from gallery 205. PIA enable control 207 toggles between enable and disable to have PIA processing before transmitting photographic image 203 in response to upload control 209. Auto/manual replace control 211 provides a trigger to solicit user input of anonymized descriptive content via entry field 213. Clear control 215 clears entry field 213. Add control 217 adds entered descriptive data such as “Go Fighting Ostriches” to anonymized content data 142 (FIG. 1).

In one or more embodiments, controller 120 (FIG. 1) is configured to cause communication device 100 to render a consent interface containing a control (e.g., PIA enable control 207) that enables or disables replacement of the PII text-based content in photographic image 203 prior to sharing photographic image 203. Controller 120 (FIG. 1) is configured to cause communication device 100 to modify display 164 to present the consent interface. Controller 120 (FIG. 1) is configured to cause communication device 100 to perform redaction of PII text-based content and inpainting of anonymized intelligible text, in response to receiving an input via the control (e.g., 207) enabling redaction of PII text-based content prior to sharing of photographic images 203.

In one or more embodiments, controller 120 (FIG. 1) is configured to cause communication device 100 to render an anonymization selection interface containing a control (e.g., entry field 213) that facilitates user input or selection of the anonymized intelligible text. Controller 120 (FIG. 1) is configured to cause communication device 100 to modify display 164 to present the anonymization selection interface. Controller 120 (FIG. 1) is configured to cause communication device 100 to inpaint the anonymized intelligible text that is received as the user input to the control. In one or more embodiments, in response to determining that the one or more photographic image does not contain PII text-based content or after inpainting anonymized intelligible text, controller 120 (FIG. 1) is configured to cause communication device 100 to trigger communication (i.e., transmit using communications subsystem via a communication network) of one or more photographic image 203 to at least one second device 104 or social media server 106.

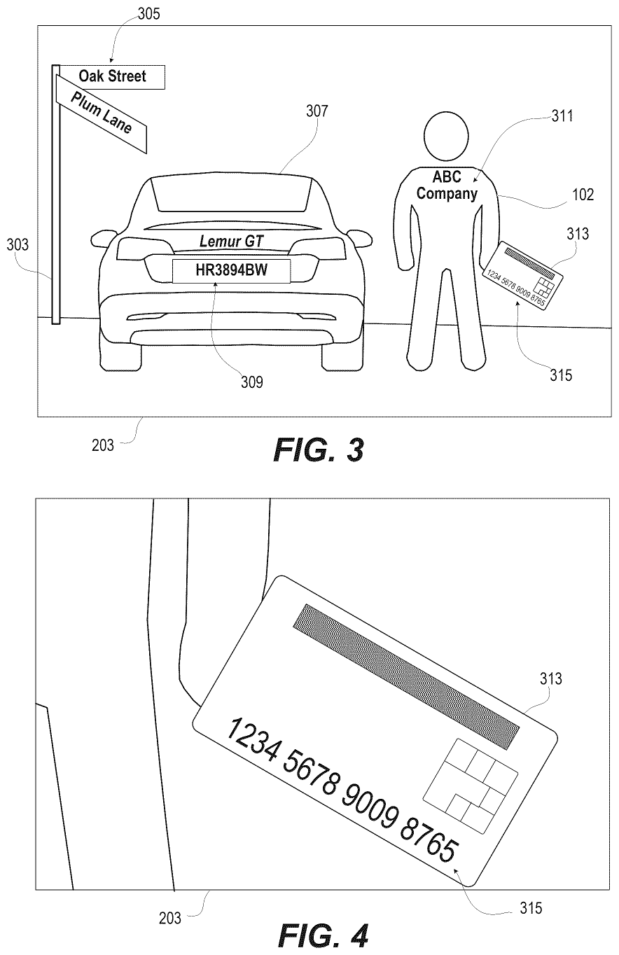

FIG. 3 is photographic image 203 containing multiple examples of PII. Street sign 303 discloses PII of street location 305 of intersection of Oak Street and Plum Lane. Vehicle 307 has model label “Lemur GT”, which is not PII as being deducible from the shape of the vehicle 307.Vehicle 307 does include PII of vehicle license tag 309 (e.g., HR3894BW). User 102 is wearing PII as shirt label 311 (e.g., “ABC company”) that potentially discloses a private affiliation of user 102. User 102 is holding debit or credit card 313 that contains PII of account number 315. FIG. 4 is a close-up view of debit or credit card 313, which can become visible/readable by zooming in on the corresponding section of the digital photographic image.

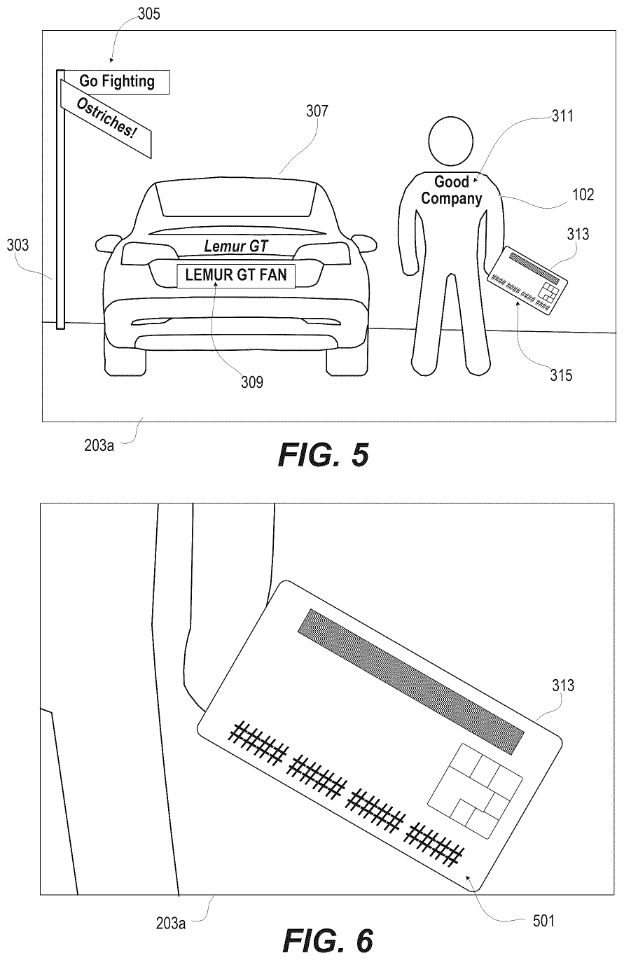

FIG. 5 is photographic image 203a having PII inpainted with anonymized intelligible descriptive data. Street sign 303 now bears user input phrase “Go Fighting Ostriches”. Vehicle identification tag 309 now bears “Lemur GT Fan”, which may be an example of automatically determining anonymizing intelligible descriptive data for the particular vehicle 307 that is recognized. Shirt label 311 bears generic “Good Company”. Account number 315 is replaced with numbers that do not correspond to actual accounts and/or other alphanumeric sequences. In an example, replacement numeral 501 (e.g., “#### #### #### ####” or “credit card number”), which may be selected based on recognizing the format of a debit or credit card account. FIG. 6 is a close-up view of debit or credit card 313 bearing slogan 501.

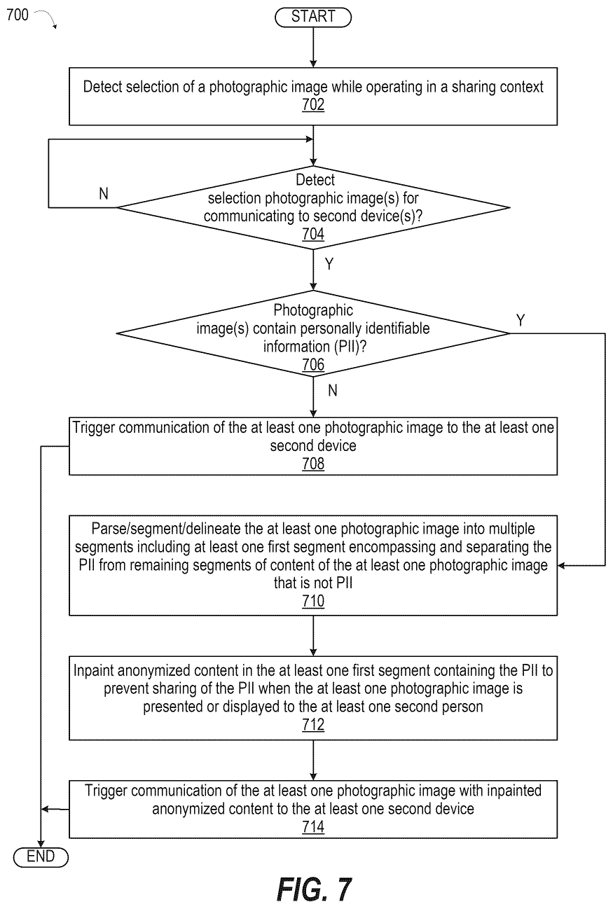

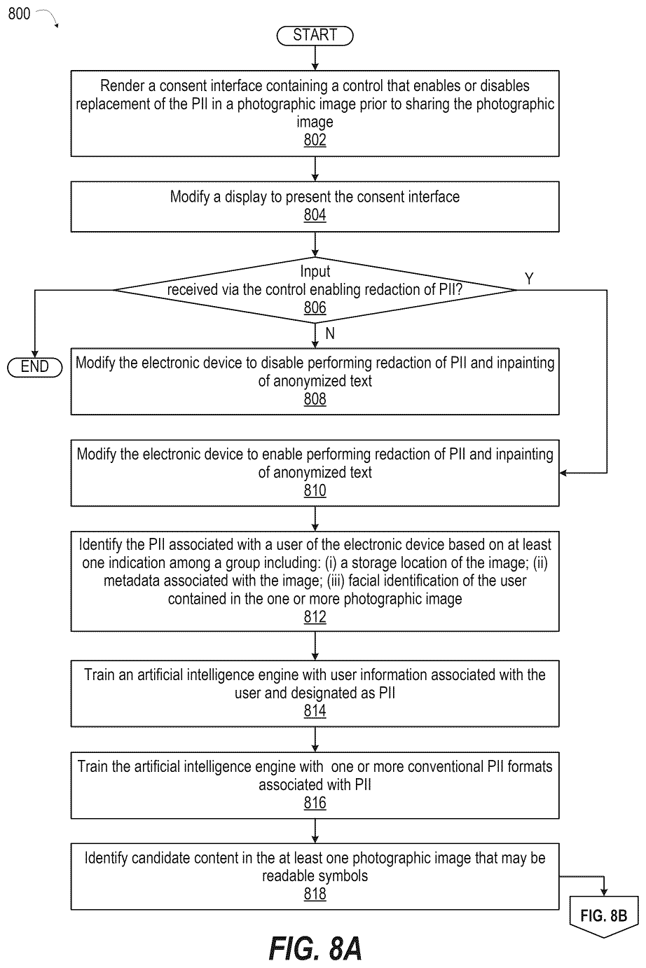

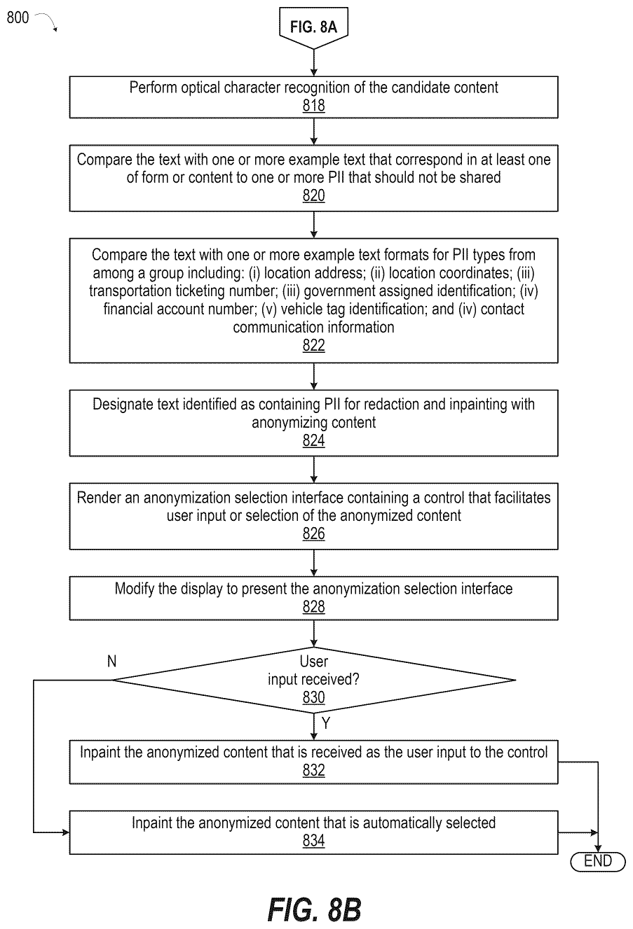

FIG. 7 is a flow diagram presenting method 700 for automatically anonymizing personally identifiable information (PII) in photographic images by inpainting anonymized intelligible descriptive data. FIGS. 8A-8B (collectively “FIG. 8”) are a flow diagram presenting method 800 that may augment method 700 (FIG. 7) with additional features for identifying PII and inpainting with anonymized intelligible descriptive data to replace the PII. The description of method 700 (FIG. 7) and method 800 (FIG. 8) are provided with general reference to the specific components illustrated within the preceding FIGS. 1-6. Specific components referenced in method 700 (FIG. 7) and method 800 (FIG. 8) may be identical or similar to components of the same name used in describing preceding FIGS. 1-6. In one or more embodiments, controller 120 (FIG. 1) configures communication device 100 (FIG. 1) or a similar computing device to provide the described functionality of method 700 (FIG. 7) and method 800 (FIG. 8).

With reference to FIG. 7, method 700 includes detecting selection of a photographic image while operating in a sharing context (block 702). The sharing context can be one from among, an open user interface for drafting a text message or email for transmission, interfacing within a social media account, engaging in a video call, etc. Method 700 includes determining whether the at least one photographic image is to be communicated to at least one second device or posted/uploaded to a social media platform that provides access for presentation of the at least one photographic image to at least one second person (decision block 704). In response to the selection of at least one photographic image not being for communicating to at least one second device or sharing to a social media platform, method 700 returns to decision block 704. In response to determining that the selection of at least one photographic image is for communicating to at least one second device or sharing to a social media platform that provides access for presentation of the at least one photographic image to at least one second person, method 700 includes dynamically identifying whether the at least one photographic image contains personally identifiable information (PII) (decision block 706). In response to determining that the at least one photographic image does not contain PII, method 700 includes processing the communication of the at least one photographic image to the at least one second device (block 708). Then method 700 ends. In response to determining that the at least one photographic image contains PII, method 700 includes parsing/segmenting/delineating the at least one photographic image into multiple segments, including at least one first segment encompassing and separating the PII from remaining segments of non-PII content of the at least one photographic image (block 710). Method 700 includes retrieving or generating intelligible anonymized content of the same format as the PII (block 712). Method 700 includes inpainting anonymized content in the at least one first segment containing the PII to prevent sharing of the PII when the at least one photographic image is presented or displayed to the at least one second person (block 714). Method 700 includes triggering communication or uploading of the at least one photographic image with inpainted anonymized content to the at least one second device or to the social media platform (block 714). Then method 700 ends.

With reference to FIG. 8A, method 800 includes rendering a consent interface containing a control that enables or disables replacement of the PII in a photographic image prior to sharing the photographic image (block 802). Method 800 includes modifying a display to present the consent interface (block 804). Method 800 includes determining whether an input is received, via the control, enabling redaction of PII prior to sharing of photographic image (decision block 806). In response to determining that an input is not received enabling redaction of PII prior to sharing of photographic image, method 800 includes modifying the electronic device to disable performing redaction of PII and inpainting of anonymized text (block 808). Then method 800 ends. In response to determining that an input is received via the control to enable redaction of PII prior to sharing of photographic image, method 800 includes modifying the electronic device to enable performing redaction of PII and inpainting of anonymized text (block 810). In one or more embodiments, method 800 includes identifying the PII associated with a user of the electronic device based on at least one indication among a group including: (i) a storage location of the image; (ii) metadata associated with the image; and (iii) facial identification of the user contained in the one or more photographic image (block 812). In one or more embodiments, method 800 includes training an artificial intelligence engine with user information associated with the user and designated as PII (block 814). Method 800 includes training the artificial intelligence engine with one or more conventional PII formats associated with PII (block 816). In one or more embodiments, method 800 includes identifying candidate content in the at least one photographic image that may be readable symbols (block 818). Then method 800 proceeds to block 818 (FIG. 8B).

With reference to FIG. 8B, method 800 includes performing optical character recognition of the text-based content (block 818). Method 800 includes comparing the text with one or more example text that correspond in at least one of form or content to one or more PII that should not be shared (block 820). Method 800 includes comparing the text with one or more example text formats for PII types from among a group including: (i) location address; (ii) location coordinates; (iii) transportation ticketing number; (iii) government assigned identification; (iv) financial account number; (v) vehicle tag identification; and (iv) contact communication information (block 822). Method 800 includes designating text identified as containing PII for redaction and inpainting with anonymizing content (block 824). In one or more embodiments, method 800 includes rendering an anonymization selection interface containing a control that facilitates user input or selection of the anonymized content (block 826). Method 800 includes modifying the display to present the anonymization selection interface (block 828). Method 800 includes determining whether a user input is received within the anonymization selection interface for user-specified anonymized intelligible descriptive data (e.g., via at least one input device of the electronic device) (decision block 830). In response to determining that a user input is received, method 800 includes inpainting the anonymized content that is received as the user input to the control (block 832). Then method 800 ends. In response to determining that a user input is not received via at least one input device of the electronic device, method 800 includes inpainting the anonymized content that is automatically generated and/or selected (block 834). Then method 800 ends.

According to aspects of the present disclosure, the communication device 100 (FIG. 1), method 700, and computer program product, such as RSD 150 (FIG. 1), automatically anonymize personally identifiable information (PII) in photographic images by inpainting anonymized intelligible descriptive data to protect a user who shares the photographic images. In an example, the anonymized photographic images are communicated to one or more second devices, posted to a social media site, or displayed on an integral or external display viewable by second person(s). The inpainting of anonymized intelligible descriptive data gives a general appearance of the replaced PII as compared to blurring or covering with a solid shape. In one or more embodiments, the anonymized intelligible descriptive data enhances the anonymized photographic image with user preferred text or automatically generated descriptions of what is in the photographic image.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one input device;
a memory comprising a personal information anonymization (PIA) module;
a communications subsystem by which the electronic device communicatively connects to one or more second device, via a network; and
a controller communicatively coupled to the at least one input device, the memory, and the communications subsystem and which is configured to cause the electronic device to:
in response to detecting selection of at least one photographic image for communicating to at least one second device that is configured to provide access for presentation of the at least one photographic image to at least one second person:
identify whether the at least one photographic image contains personally identifiable information (PII); and
in response to determining that the at least one photographic image contains PII:
delineate the at least one photographic image into multiple segments comprising at least one first segment encompassing and separating the PII from remaining segments of content of the at least one photographic image that is not PII; and
inpaint anonymized intelligible descriptive data in the at least one first segment containing the PII to prevent sharing of the PII when the at least one photographic image is presented or displayed to the at least one second person.

2. The electronic device of claim 1, wherein, in identifying whether the at least one photographic image contains the PII, the controller configures the electronic device to identify whether the at least one photograph once communicated to the one or more second electronic device will contain an indication of a user of the electronic device being associated with the one or more photographic images based on at least one indication from a group comprising: (i) a storage location of the image being associated with at least one image capturing device of the electronic device; (ii) metadata associated with the image identifying the user; and (iii) facial identification of the user contained in the one or more photographic image.

3. The electronic device of claim 1, wherein, in identifying whether the at least one photographic image contains the PII, the controller is configured to cause the electronic device to:
perform optical character recognition of text-based content contained in the at least one photographic image;
compare the text-based content with one or more example text that correspond in at least one of form or content to one or more predesignated PII text-based content that should not be shared;
redact text-based content identified as containing the PII text-based content; and
replace the text-based content with intelligible descriptive text identified as a generic substitute text.

4. The electronic device of claim 3, wherein the controller is configured to cause the electronic device to:
identify a text format for PII types from among a group comprising: (i) location address; (ii) location coordinates; (iii) transportation ticketing number; (iii) government assigned identification; (iv) financial account number; (v) vehicle tag identification; and (iv) contact communication information.

5. The electronic device of claim 1, further comprising a display communicatively coupled to the controller, wherein the controller is configured to cause the electronic device to:
render a consent interface containing a control that enables or disables replacement of PII text-based content in a photographic image prior to sharing the photographic image;
modify the display to present the consent interface; and
modify the electronic device to perform redaction of PII text-based content and inpainting of anonymized intelligible text, in response to receiving an input via the control enabling redaction of PII text-based content prior to sharing of photographic images.

6. The electronic device of claim 1, wherein, in analyzing the at least one photographic image for one or more candidate segments that contain PII text-based content; the controller is configured to cause the electronic device to:
train an artificial intelligence engine with user information associated with a user of the electronic device and with one or more conventional PII formats to identify the PII text-based content associated with the user.

7. The electronic device of claim 6, wherein the PII comprises alphanumeric content associated with a user of the electronic device, and the controller is configured to train the artificial intelligence engine to:
identify one or more descriptive characteristics of content within the photographic image;
generate intelligible descriptive alphanumeric content that is associated with the one or more descriptive characteristics of the content within eh photographic image; and
to inpaint the anonymized intelligible descriptive data, inpaint the intelligible descriptive alphanumeric content.

8. The electronic device of claim 1, further comprising a display communicatively coupled to the controller, wherein the controller is configured to cause the electronic device to:
render an anonymization selection interface containing a control that facilitates user input or selection of anonymized intelligible text;
modify the display to present the anonymization selection interface; and
inpaint the anonymized intelligible text that is received as the user input to the control.

9. The electronic device of claim 1, wherein the controller is configured to cause the electronic device to:
in response to determining that the one or more photographic image does not contain PII text-based content or after inpainting anonymized intelligible text, trigger communication of the one or more photographic image to the at least one second device.

10. A method comprising:
in response to detecting selection of at least one photographic image for communicating to at least one second device that is configured to provide access for presentation of the at least one photographic image to at least one second person:
identifying whether the at least one photographic image contains personally identifiable information (PII); and
in response to determining that the at least one photographic image contains PII:
delineating the at least one photographic image into multiple segments comprising at least one first segment encompassing and separating the PII from remaining segments of content of the at least one photographic image that is not PII; and
inpainting anonymized intelligible descriptive data in the at least one first segment containing the PII to prevent sharing of the PII when the at least one photographic image is presented or displayed to the at least one second person.

11. The method of claim 10, wherein identifying whether the at least one photographic image contains the PII further comprises identifying whether the at least one photograph once communicated to one or more second electronic device will contain an indication of a user of the electronic device being associated with the one or more photographic images based on at least one indication from a group comprising: (i) a storage location of the image being associated with at least one image capturing device of the electronic device; (ii) metadata associated with the image identifying the user; and (iii) facial identification of the user contained in the one or more photographic image.

12. The method of claim 10, wherein identifying whether the at least one photographic image contains the PII further comprises:
performing optical character recognition of text-based content contained in the at least one photographic image;
comparing the text-based content with one or more example text that correspond in at least one of form or content to one or more predesignated PII text-based content that should not be shared;
redacting text-based content identified as containing the PII text-based content; and
replacing the text-based content with intelligible descriptive text identified as a generic substitute text.

13. The method of claim 12, wherein identifying whether the at least one photographic image contains the PII further comprises:
identifying a text format for PII types from among a group comprising: (i) location address; (ii) location coordinates; (iii) transportation ticketing number; (iii) government assigned identification; (iv) financial account number; (v) vehicle tag identification; and (iv) contact communication information.

14. The method of claim 10, further comprising:
rendering a consent interface containing a control that enables or disables replacement of PII text-based content in a photographic image prior to sharing the photographic image;
modifying a display to present the consent interface; and
performing redaction of PII text-based content and inpainting of anonymized intelligible text, in response to receiving an input via the control enabling redaction of PII text-based content prior to sharing of photographic images.

15. The method of claim 10, wherein analyzing the at least one photographic image for one or more candidate segments that contain PII text-based content further comprises:
training an artificial intelligence engine with user information associated with a user of an electronic device and with one or more conventional PII formats to identify the PII text-based content associated with the user.

16. The method of claim 15, wherein the PII comprises alphanumeric content associated with a user of the electronic device, and the method further comprises training the artificial engine to:
identify one or more descriptive characteristics of content within the photographic image;
generate intelligible descriptive alphanumeric content that is associated with the one or more descriptive characteristics of the content within eh photographic image; and
to inpaint the anonymized intelligible descriptive data, inpaint the intelligible descriptive alphanumeric content.

17. The method of claim 10, further comprising:
rendering an anonymization selection interface containing a control that facilitates user input or selection of anonymized intelligible text;
modifying a display to present the anonymization selection interface; and
inpainting the anonymized intelligible text that is received as the user input to the control.

18. The method of claim 10, further comprising:
in response to determining that one or more photographic image does not contain PII text-based content or after inpainting anonymized intelligible text, triggering communication of the one or more photographic image to the at least one second device.

19. A computer program product comprising:
a computer readable storage device; and
program code on the computer readable storage device that when executed by a processor associated with an electronic device, the program code configures the electronic device to provide functionality of:
communicatively connecting, via a communications subsystem of an electronic device, to one or more second device, via a network; and
in response to detecting selection of at least one photographic image for communicating to at least one second device that is configured to provide access for presentation of the at least one photographic image to at least one second person:
identifying whether the at least one photographic image contains personally identifiable information (PII); and
in response to determining that the at least one photographic image contains PII:
delineating the at least one photographic image into multiple segments comprising at least one first segment encompassing and separating the PII from remaining segments of content of the at least one photographic image that is not PII; and
inpainting anonymized intelligible descriptive data in the at least one first segment containing the PII to prevent sharing of the PII when the at least one photographic image is presented or displayed to the at least one second person.

20. The computer program product of claim 19, wherein identifying whether the at least one photographic image contains the PII further comprises identifying whether the at least one photograph once communicated to the one or more second electronic device will contain an indication of a user of the electronic device being associated with the one or more photographic images based on at least one indication from a group comprising: (i) a storage location of the image being associated with at least one image capturing device of the electronic device; (ii) metadata associated with the image identifying the user; and (iii) facial identification of the user contained in the one or more photographic image.
